(19) United States
(12) Patent Application Publication
(10) Pub. No.: US 2025/0164280 A1
(43) Pub. Date: May 22, 2025

(54) METHOD FOR VERSIONING DIGITAL ROAD MAPS AND VEHICLE

(71) Applicant: MERCEDES-BENZ GROUP AG, Stuttgart (DE)

(72) Inventors: Thomas MONNINGER, Menlo Park, CA (US); Mario ALEKSIC, Stuttgart (DE); Alexander BRACHT, Esslingen (DE); Peter HURT, Filderstadt (DE); Anja SEVERIN, Stuttgart (DE); Michael MINK, Ammerbuch (DE); Maximilian HARR, Mötzingen (DE); Roland ORTLOFF, Gärtringen (DE); Michael HENZLER, Stuttgart (DE)

(21) Appl. No.: 18/832,740

(22) PCT Filed: Dec. 2, 2022
(86) PCT No.: PCT/EP2022/084265

§ 371 Date: Jul. 24, 2024

(30) Foreign Application Priority Data
Jan. 25, 2022 (DE) 10 2022 000 272.8

(51) Int. Cl. G01C 21/00

(52) U.S. Cl. CPC G01C 21/3896; G01C 21/3859

(57) ABSTRACT

Incremental updates are used for versioning digital road maps. A base map is provide. A hash function is applied to the base map to generate a version hash of the base map. Map difference bundles are provided, a map difference bundle includes at least one individual change of a map feature. The digital road map is versioned by forming at least one continuous version chain, beginning with the base map. To generate a current map version, a map difference bundle to be applied is linked to the map version in the version chain before the current map version. For this the version hash of the previous map version and the map difference bundle to be applied are input into the hash function as input parameters to generate a version hash for the current map version.

### BACKGROUND AND SUMMARY OF THE INVENTION

Exemplary embodiments of the invention relate to a method for versioning digital road maps by means of incremental updates and a vehicle having a processing unit for carrying out the method.

Digital roadmaps are used by vehicles in a variety of ways. For example, digital road maps are used for determining and presenting navigation routes. Information stored in a digital road map can also be used for controlling vehicle functions of automated and autonomous vehicles. The greater the degree of automation of the vehicle, the more exact road map information is required. The information should additionally be as up to date as possible.

For this purpose, digital road maps are updated regularly. This update is often carried out via mobile communication. To reduce the amount of data to be transmitted here, so-called differential or incremental updates are often used in this context. Here, the complete monolithic dataset of the digital road map is not replaced, but rather only the differences between the outdated and the current map version are uploaded.

The disadvantage here, however, is that managing different versions of the digital road map is associated with a high degree of effort. Retaining different map versions can be important for a map manufacturer, since they might want to offer different maps for different clients, for example. There can also be interest in providing different map versions for one and the same geographical region, for example for different uses. For this, individual map versions can be duplicated in a so-called “fork” and then carried forward as a separate strand of the map. This increases the degree of effort for managing different map versions further still, since now both strands of the map have to be maintained. In addition, this method is prone to error since, due to the increased manual effort, the risk of changes to individual map versions being forgotten or incorrectly implemented also increases.

Furthermore, it is not possible to upload selective changes to different map versions. It is thus not possible to combine different versions of the map, but instead changes have to be uploaded one after the other.

A method for updating a digital map is known from application DE 10 2016 219 258 A1. The disclosed method simplifies carrying out incremental updates of maps present in different versions. Here, updates for the same map objects for different versions of the map are saved in an update dataset. The scope of such an update dataset is correspondingly large.

Furthermore, publication DE 10 2015 206 519 A1 discloses a method for updating digital road maps divided into individual tiles by means of differential updates. Here, only the changes that are not yet present in the map tile to be updated are uploaded for the map tiles to be updated. Here too there is a set order according to which updates are uploaded to the digital road map. The random combination of changes is not possible.

A method for incrementally updating digital road maps using versioning is known from CN 1 02 607 576 A. Here, based on an initial base map, a hash function is applied to the base map. Map difference bundles are provided based on an alignment of hash tables of target and actual versions of the digital road map. However, no direct versioning of the digital road map is disclosed, but rather indirect versioning by versioning map objects.

The application DE 10 2004 001 797 A1 also shows a method for incrementally updating digital road maps using versioning. Here, map difference bundles are provided, which comprise changes of at least one individual change of a map feature. The application of a hash function to the base map for generating the version hash is not disclosed.

US 2021/0 026 834 A1 discloses a method for checking software and data updates for vehicles based on blockchain technology. The method applies a hash function to initial data and further stored information and generates dedicated hashes as part of a Merkle hash tree. The provision of map difference bundles and the application of blockchain technology on versioning are not disclosed.

Exemplary embodiments of the present invention are directed to an improved method for versioning digital road maps by means of incremental updates, which enables the management and use of different versions of the digital road map with a comparatively low degree of effort.

In a method according to the invention for versioning digital road maps by means of incremental updates, the following method steps are carried out according to the invention:
providing a base map;
applying a hash function to the base map for generating a version hash of the base map;
providing map difference bundles, wherein a map difference bundle comprises at least one individual change of a map feature;
versioning the digital road map by forming at least one continuous version chain, beginning with the base map, wherein for this:
to generate a current map version, a map difference bundle to be applied is linked to the map version in the version chain before the current map version, wherein for this the version hash of the previous map version and the map difference bundles to be applied are used as input parameters in the hash function in order to generate a version hash for the current map version.

The management and use of different map versions is made possible particularly easily by means of the method according to the invention. Thus, on one hand, the processing effort and memory consumption required to update digital road maps can be reduced by means of the method according to the invention, since incremental updates in the form of map difference packets are used to update the base map stored as a monolithic dataset. On the other hand, a particularly high degree of flexibility when updating the digital road maps is made possible by the management as a version chain, such that any version statuses of a digital road map can be combined with any map difference bundles without much effort.

Here, the main idea of the invention is the management of the digital road map in the manner of a blockchain. Here, the base map constitutes the output block, which is converted to a version chain of different map versions by means of the link with map difference bundles. However, in comparison to a cryptocurrency, such as Bitcoin, for example, here there is not only an individual version chain, but instead any number of version chains can be generated based on the base map. Here, different map versions can also be combined with one another, if possible, and thus combined to form new version chains.

A linking of a current map version to the previous map version is required, since only the changes are stored per map version. Each map version can be identified by a unique ID in the form of the version hash. This makes possible a particularly simple comparison of the different map versions to one another. In addition, the linking of the individual map versions to one another to form the version chain using hash functions guarantees the protection from the data being tampering with. Thus, changes cannot be tampered with and, in addition, can be clearly traced. The linking to the previous map version here only requires the storage of the version hash of the previous map version, whereby the memory requirements of the current map version are required.

As already mentioned, the version changes are modular, whereby individual map difference bundles can be applied to the base map randomly combined with one another. This clearly simplifies the effort for a map provider for providing different client-specific map strands. Instead of duplicating the base map and incorporating future changes separately into both version strands, it is possible by means of the method according to the invention to automatically apply map differences to different version chains.

With the availability of a random map version, the map history is also implicitly available. This means that all map versions are always available with minimal memory consumption. If a certain map version is now to be used, the map difference bundles to be applied for the respective map version are correspondingly applied to the base map. Thus, this makes it possible to jump back to the last functional map version from an erroneous digital road map.

Calculating the version hash is additionally possible with a comparatively low degree of processing effort. Thus, only the version hash of the previous map version and the change to be applied are incorporated in the hash function. For this, substantially less processing capacity is necessary than when calculating a hash based on a complete monolithic dataset, for example.

Furthermore, the digital road map can also be divided into individual tiles.

In a processing system, one or even several base maps can be carried along, and the method according to the invention can be respectively applied to the individual base maps. For example, a first base map can correspond to the geographical region of a first country, for example Germany, and a second base map to a second geographical region, such as France, for example. According to an embodiment of the method according to the invention which will be expanded on further later, the digital road maps can be used in a vehicle, whereby, for example during a journey of a person driving the vehicle from Germany to France, the base map used for France when starting the journey is updated or augmented according to the method according to the invention.

The map features are map objects, such as individual street sections, junctions and similar, for example, and the map object properties valid for these map objects, for example a speed limit valid for the respective map object, hazard warning, geo-position data or similar.

An advantageous development of the method according to the invention provides that a current map version is only incorporated into the version chain when an authorizing instance releases the current map version. In doing so, the integrity of the version chain is retained. Thus, the effects of new map difference bundles on different map versions can be examined by a developer team, for example, and only those map difference bundles in which the corresponding current map version runs stably can be released for generating current map versions. This process is also referred to as the “staging concept”. Thus, a certain map version is frozen and declared as a stable branch. Updates are then continued on a so-called development branch. Only relevant and/or critical changes can then be adopted in the stable branch. The authorizing instance can be, for example, the developer team or a mapping office.

Corresponding to a further advantageous design of the method, the base map and the map difference bundles are retained in a central database on a central processing unit. This makes it possible to centrally access the base map and the map difference bundle, such that the base map and the map difference bundle can be made accessible simultaneously for a high number of different agents. Thus, new map difference bundles can be incorporated into the central database, for example, and correspondingly distributed to clients or users of the digital road map. The central processing unit can be a Cloud server, for example. For example, the Cloud server can be operated by a map producer or even a vehicle manufacturer.

A further advantageous design of the method according to the invention further provides that
the base map is introduced into a processing unit of a vehicle;
a selection of map difference bundles is introduced into the processing unit of the vehicle;
the digital road map in the processing unit of the vehicle is versioned by forming at least one continuous version chain using at least one partial amount of the selection of map difference bundles; and
a current map version of the digital road map in the vehicle is applied using a vehicle function.

The vehicle function can be, for example, an at least partially automated operating mode of the vehicle, which reads relevant information from the current map version to control the vehicle. A further vehicle function could correspond to the depiction of the current map version of the digital road map on a display device in the vehicle.

Preferably, a lower number of map difference bundles is here incorporated into the processing unit of the vehicle than are retained in the central database. In doing so, the memory consumption in the vehicle and a bandwidth required for transmitting the map difference bundles can be reduced. Here, map difference bundles relevant to the vehicle, in particular, are transmitted to the processing unit. To determine relevant map difference bundles, a journey route planned with the vehicle, for example, can be analyzed. Then, for map sections along which the journey route runs, valid map difference bundles are transmitted from the central database to the processing unit. In general, it is, however, also possible that only one individual map difference bundle is transmitted to the processing unit of the vehicle.

To generate the current map version, it can already suffice to apply, to the corresponding base map, only one partial amount of the selection of map difference bundles transmitted to the vehicle. Several version chains can also be generated, whereby this makes it possible to switch back and forth between different current map versions in the vehicle particularly quickly and easily.

According to a further advantageous design of the method, a processing unit in the vehicle uses a current map version of the digital road map for ascertaining a navigation route from a current position to a target destination. This makes particularly reliable navigation control possible, since a current map version is thus always used for calculating the navigation route. The vehicle can generally comprise one or even several processing units. Here, a first processing unit can be provided for stockpiling the base map and the map difference bundles and for generating the continuous version chain of the digital road map and a further processing unit for carrying out the navigation. The two functions, however, can also be integrated into one and the same processing unit.

The processing unit can be fixedly integrated into the vehicle or be formed by a mobile terminal, which communicates with a processing unit fixedly integrated into the vehicle. The mobile terminal can be, for example, a smartphone on which an application is performed, which makes it possible to carry out the method according to the invention. Here, the smartphone can communicate with the central processing unit, for example by mobile communication.

According to a further advantageous design of the method according to the invention, this also makes it possible to wirelessly introduce the base map and/or the selection of map difference bundles into the processing unit of the vehicle. In general, it is, however, also conceivable that the base map and/or a selection of map difference bundles is introduced into the processing unit in a wired manner, for example during a maintenance interval of the vehicle. In this context, wired includes reading any physical storage medium using the processing unit, such as reading, for example, an SD card, a USB stick, an optical storage medium, such as a DVD or a Blu-ray, or similar.

Communication between the processing unit of the vehicle and the central processing unit can also be carried out via a wireless communication interface, for example a telematics unit fixedly installed in the vehicle. Along with mobile communications, any wireless communication technologies, such as Bluetooth, NFC, WLAN, in particular using Wi-Fi standard, and similar, for example, come into consideration for the communication.

According to the invention, in a vehicle with a processing unit, the processing unit is set up to carry out a method described above. The vehicle can be any vehicle, such as a car, lorry, van, bus, or similar. The vehicle can have at least one at least partially automated driving function, in particular such a driving function that is instructed to provide and process current map data.

Further advantageous designs of the method according to the invention for versioning digital road maps by means of incremental updates and of the vehicle emerge from the exemplary embodiments which are described in more detail below with reference to the figures.

### BRIEF DESCRIPTION OF THE DRAWING FIGURES

Here are shown:

FIG. 1 a schematic procedure for versioning digital road maps by means of incremental updates according to a known process;

FIG. 2 a schematic detailed view of a map difference bundle;

FIG. 3 a schematic depiction of a dataset to be stored of a digital road map when the digital road map is updated according to a method according to the invention;

FIG. 4 a schematic process for generating a version chain of successive map versions;

FIG. 5 a schematic view of an ecosystem used for carrying out the method according to the invention; and

FIG. 6 a schematic depiction of generating different version chains of the digital road map in a vehicle.

### DETAILED DESCRIPTION

FIG. 1 shows the process for generating different versions of a digital road map by means of incremental updates, as known from the prior art. Monolithic datasets, i.e., interrelated comparatively large files for forming a digital road map, are here symbolized in the figures by boxes with a thick black outline. As FIG. 1 shows, a first map version KV1 of a digital road map is updated by uploading a first map difference bundle Δ1 to a new version. Here, only map features to be changed of the first map version KV1 are changed. In doing so, the version identifier of the digital road map is increased, such that a second map version KV2 emerges. The second map version KV2 is then also saved as a monolithic data block.

Analogously, by uploading a second map difference bundle Δ2, the second map version KV2 is updated to a first third map version KV3. For a third map version KV3, different variants are to be generated, for example for different application purposes or different clients. Thus, a third map difference bundle Δ3 is applied to the second map version KV2, in order to still generate a second third map version KV3.2 along with a first second map version KV3.1. This process is also referred to as “forking”.

By uploading a fourth, fifth and sixth map difference bundle Δ4, Δ5, Δ6, further map versions KV4, KV3.2.1 and KV3.2.2 are analogously generated. This is associated with a comparatively high degree of effort, since any map versions are formed by a monolithic dataset, and updates have to correspondingly uploaded to this in order to maintain it. In addition, a high memory consumption is required since each map version KV1, KV2, KV3.1, KV3.2, KV4, KV3.2.1, KV3.2.2 has to be saved as a monolithic dataset.

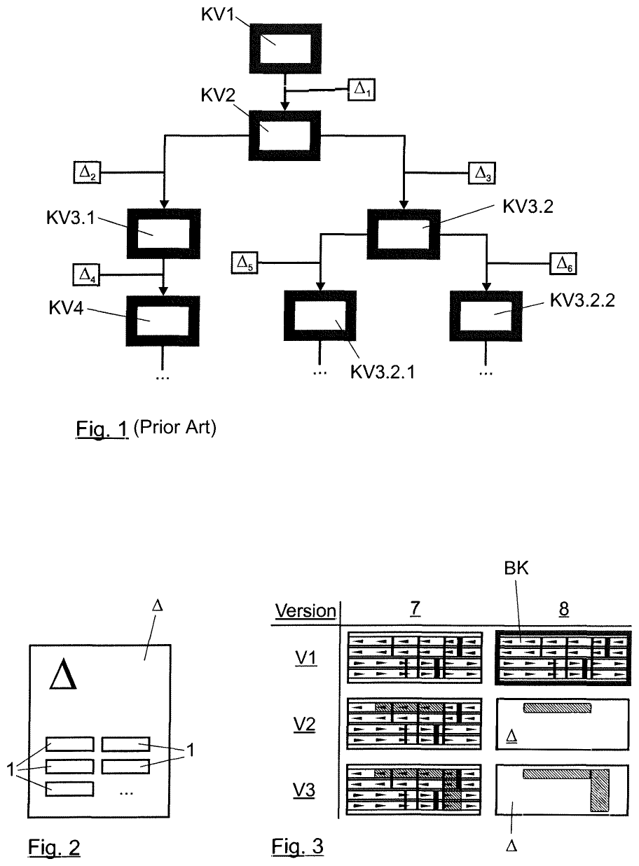

FIG. 2 shows a detailed view of a map difference bundle Δ. A map difference bundle Δ comprises at least one individual change 1 of a map feature. However, as depicted in FIG. 2, a map difference bundle Δ can also comprise several individual changes 1 for different map features. In general, it is here also possible that each map difference bundle Δ only comprises a single individual change 1.

A map feature can be a combination of map object, i.e., a street section, for example, a junction, a traffic sign, a set of traffic lights or similar, and map object properties valid for the respective map object, i.e., an applicable speed limit, for example, a direction of travel, a period of time, a geo-position or similar.

By means of a method according to the invention, it is possible to considerably reduce the effort for generating, managing and using different versions of the digital road map. Thus, FIG. 3 shows a schematic depiction of a dataset to be stored of the digital road map. The depiction is made as a table, wherein the first column of the table shows a version identifier version of the digital road map, the second column a complete dataset 7, and the third column the version change 8 to be respectively stored. As can be seen, in the first version V1, the complete digital road map is saved as a monolithic dataset in the form of a base map BK. To update to a second version V2, a change is uploaded to the digital road map. Here, only the change shown in the second row and third column is saved in the form of a map difference bundle Δ. Analogously, for a third version V3, only the change shown in the third row and third column is saved. Thus, for different versions of the map, no complete monolithic datasets have to be stored in each case, but only the monolithic dataset of the base map BK and the changes to be applied by the map difference bundles Δ. This makes it possible to particularly efficiently manage the data with respect to the amounts of data to be transmitted and to be saved.

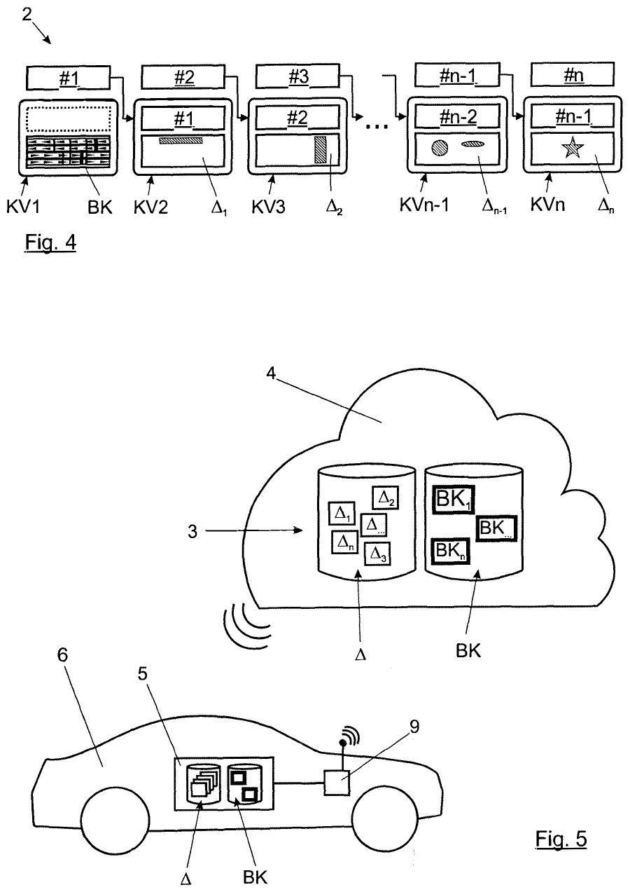

According to the invention, to generate a current map version KVn, the individual map versions of the digital road map are strung together in the form of a version chain 2, as depicted in FIG. 4. To do so, a version hash #n-1 of a previous map version KVn-1 and a map difference bundle Δn to be applied are fed into a hash function as input parameters, in order to generate a version hash #n for the current map version KVn. The process shown in FIG. 4 here begins with the base map BK and the generation of a first version hash #1. The base map BK here constitutes a first map version KV1. The first version hash #1 is fed into the hash function with a first map difference bundle Δ1, in order to generate a second version hash #2. The first version hash #1 and the first map difference bundle Δ1 here form a second map version KV2.

Analogously, the second version hash #2 and a second map difference bundle Δ2 are included in the hash function to form a third map version KV3 in order to generate a third version hash #3.

The process for generating the version chain 2 can thus be compared to generating a blockchain. Generating version hashes on the respective map version here ensures that changes to a digital road map cannot be tampered with and can clearly be traced.

FIG. 5 shows an ecosystem used for carrying out the method according to the invention. This comprises a central processing unit 4, for example a Cloud server, which comprises a central database 3. The base map BK and the different map difference bundles Δ are stored in the central database 3. Here, a plurality of different map difference bundles Δ is shown in FIG. 5, wherein different map difference bundles are symbolized in the index by a different number. The central database 3 can be used to store different base maps BK. For example, a first base map BK1 and a second base map BK2 are stored in the central database 3. Here, a respective base map BK1, BK2 can form a digital road map of a different geographical region, for example different countries.

The method according to the invention is used to update a digital road map stored in a vehicle 6. To do so, the vehicle 6 comprises a processing unit 5, in which at least one base map BK and at least one selection of the map difference bundles Δ are stored. To communicate with the central processing unit 4, the vehicle 6 has a wireless communication interface 9.

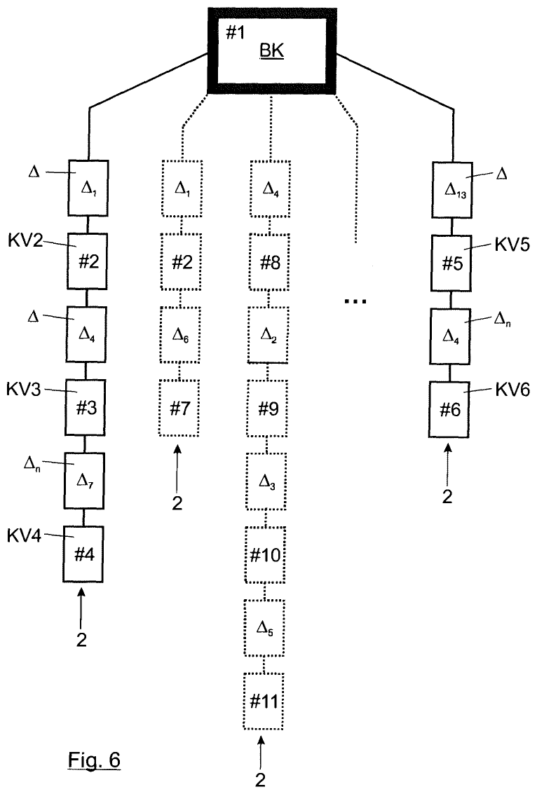

As shown in FIG. 6, one or even several different version chains 2 can be generated in the vehicle 6 according to the process shown in FIG. 4. To do so, the selection of map difference bundles Δ stored in the processing unit 5 are used. Here, different combinations of map difference bundles Δ can be used for the respective version chains 2. Version chains 2 actively used in the vehicle are symbolized in FIG. 6 by a solid line and version chains 2 that can be generated by a dashed line.

As depicted, it is possible that more than one version chain 2 is also used simultaneously in the vehicle 6. Thus, different vehicle functions, for example, can use different map versions. For example, a navigation system can use a fourth map version KV4 and a system for deriving automated control commands for the vehicle 6 a sixth map version KV6. To generate the fourth map version KV4 and sixth map version KV6, the second and third map versions KV2 and KV3 and a fifth map version KV5 have here been generated in the respective version chains 2. As a result of only one single base map BK having to be retained as a monolithic data bundle, the storage space present in the vehicle 6 can thus be utilized particularly efficiently. In addition, new updates can be uploaded particularly quickly and reliably. It is particularly quick and easy to switch between different map versions for different application cases.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-7. (canceled)

8. A method for versioning digital road maps by incremental updates, the method comprising:
providing a base map;
applying a hash function to the base map to generate a version hash of the base map;
providing map difference bundles, wherein each map difference bundle comprises at least one individual change of a map feature;
versioning the digital road map by forming at least one continuous version chain beginning with the base map, wherein the forming the at least one continuous version chain comprises
generating a current map version by linking a map difference bundle to be applied to a map version in the at least one continuous version chain before the current map version, wherein the map difference bundle to be applied is one of the provided map difference bundles,
wherein the linking involves generating a version hash for the current map version by applying the hash function to a version hash for the map version in the at least one continuous version chain before the current map version and the map difference bundle to be applied.

9. The method of claim 8, wherein the current map version is only incorporated into the at least one continuous version chain when an authorizing instance releases the current map version.

10. The method of claim 8, wherein the base map and the map difference bundles are retained in a central database on a central processing unit.

11. The method of claim 8, further comprising:
providing a vehicle with the base map;
providing the vehicle with a selection of map difference bundles;
versioning, by the vehicle, the digital road map by forming at least one continuous version chain using at least one partial amount of the selection of map difference bundles; and
using the current map version of the digital road map by a vehicle function of the vehicle.

12. The method of claim 11, wherein the vehicle uses a current map version of the digital road map to determine a navigation route from a current position of the vehicle to a destination.

13. The method of claim 11, wherein the base map or the selection of map difference bundles is wirelessly provided to the vehicle.

14. A vehicle comprising a processing unit configured to
receive a base map;
apply a hash function to the base map to generate a version hash of the base map;
receive map difference bundles, wherein each map difference bundle comprises at least one individual change of a map feature;
version the digital road map by forming at least one continuous version chain beginning with the base map, wherein the forming the at least one continuous version chain comprises
generating a current map version by linking a map difference bundle to be applied to a map version in the at least one continuous version chain before the current map version, wherein the map difference bundle to be applied is one of the provided map difference bundles,
wherein the linking involves generating a version hash for the current map version by applying the hash function to a version hash for the map version in the at least one continuous version chain before the current map version and the map difference bundle to be applied.
